(19) United States
(12) Patent Application Publication
(10) Pub. No.: US 2022/0092522 A1
(43) Pub. Date: Mar. 24, 2022

(54) Mobile iOS

(71) Applicant: Elimelech Shmi Hebrew, Houston, TX (US)

(72) Inventor: Elimelech Shmi Hebrew, Houston, TX (US)

(21) Appl. No.: 16/948,439

(22) Filed: Sep. 18, 2020

(51) Int. Cl. G06Q 10/08; G06F 8/61; G06Q 30/00; H04L 29/08

(52) U.S. Cl. CPC G06Q 10/087; G06F 8/61; G06F 3/0482; H04L 67/34; G06Q 30/0185

(57) ABSTRACT

In accordance with the present invention, the Mobile Inventory Operating System (Mobile iOS) is a mobile method of computing, controlling, monitoring, and managing inventory using a mobile device(s) (e.g., smartphones, tablets, smart watches, etc.) to collect, calculate, and index inventory data for microeconomic and macroeconomic use.

### FIELD OF INVENTION

In accordance with the present invention, the Mobile Inventory Operating System (Mobile iOS)© is a mobile software application developed with an innovative method of accumulating, computing, regulating, monitoring, indexing, and managing inventory. Moreover, the Mobile iOS© dual processing smart-technology calculates and formulates the gross sale totals independently of a point of sale (POS) system; will provide the user at the end of each day, and or the end of each shift, with the inventory entered, the gross sales output via mobile devices. (smartphone, tablet, smartwatch, etc.), for microeconomic and macroeconomic use, included but not limited to, retail, concession, manufactures, distributors and warehousing industries.

### BACKGROUND OF THE INVENTION

The management of inventory is a critical business function no matter the company's industry size or location. The Mobile iOS© is a mobile software application developed with an innovative method of computing, regulating, monitoring, indexing and managing inventory along with the technology to obtain the gross sales totals output independently rendering the traditional point of sale system obsolete. The advanced method in which the Mobile iOS© computes and modifies inventory along with its dual processing ability to obtain the gross sales self-subsistent of the traditional point of sales system differentiates the Mobile iOS© from any other mobile inventory operating system. With the advent of mobile technology came a vast array of mobile capabilities which introduced a new perspective on how mobile technology could be incorporated and used to process inventory by way of mobile devices, understanding that mobile technology is becoming a part of everyday life globally as statistics are indicating. According to statistics in the United States alone smartphone usage has grown to 95% and regarding the workforce more than half of executives, managers, and employees have a smartphone in their pocket. There has been an increase in tablet use as well growing from 3% in 2010 to 53% in 2018. Technology, mobility and instant connection has become the norm whether they are an executive at a major corporation, work in the field of retail, concessions or warehousing industry, the need for mobile technology is prevalent. Although the demand and popularity of mobile devices and their capability to process data with speed and accuracy, there has been little to no advancement in the use of mobile technology specifically developed to process inventory for microeconomic and macroeconomic use. My Mobile iOS advanced procedure of accumulating, computing, regulating, monitoring, indexing, and managing inventory using dual processing technology, will revolutionize the method of processing inventory for the future. The background for my invention of the Mobile iOS© was based on a problematic issue my company Divine Unity 1, Inc. a 501 (c) (3) nonprofit corporation had when we were losing money due to inventory shortages, inventory inaccuracies. Routinely my company would lose money because of faulty point of sales (POS) calculations that we had no way of disputing because we were not given the final sales totals for the event, nor were we trained on ways of keeping track of the inventory. My company Divine Unity 1, Inc., fundraise by operating concession stands as a non for profit (subcontractor vendor) volunteering for Aramark and Levi Restaurants, the two largest sports and entertainment, food service, facilities management, and uniform service providers, in the country, along with various other companies for which maintaining accurate inventory counts is imperative and critical to function and succeed. Conversely, my company, as many of the nonprofit subcontractor vendors, lose hundreds of dollars per event due to inventory shortages, erred inventory counts and inaccurate point of sale (POS) final sale totals. The stress and heartache brought upon me from seemingly endless inventory shortages, inventory inaccuracies, and faulty point of sale (POS) final sales totals that were costing my company, as well as others to lose hundreds and thousands of dollars per commission payout became too much. This quandary prompted me to invent the Mobile iOS© With the invention of my Mobile inventory Operating System, the process of calculating and managing inventory was simplified, efficiently and accurately reducing shortages. This invention also gave my company the ability to calculate our gross sales independently of the point of sale (POS) system provided to us. This invention was an astounding achievement because we not only know our inventory count, we know our gross sales totals as well. My Mobile iOS© software's dual processing ability to gather the inventory counts and the gross sales, is imperative to have because the user has the inventory count and access to the point of sale data. With this data the user can compare inventory counts and the point of sale gross totals for any discrepancies that may occur. The technology executed in the Mobile iOS© software application has helped my company to succeed by saving thousands of dollars while improving our bottom-line. After more than a decade of using the Mobile iOS© to manage our inventory, and researching the results thereof, I and my business associates have discovered that there are four key reasons for companies' losses in revenue.
1) Losses due to employee/vendor error
2) Losses due to employee/vendor theft
3) Losses due to inaccurate inventory counts
4) Losses due to point of sale (POS) inaccuracy.
Product, payroll, employee turnover, the inability to retain nonprofit subcontractor vendors, and the needless long hours spent posting after an event, are based on these four key reasons discovered by the Mobile iOS©

The first reason is employee/vendor error, human err is a part of everyday existence, but we have learned by extensive research in the retail, vendor, and warehousing industry that most employee/vendor errors were predicated on little to no education or professional training on how to operate an inventory system or there was no inventory system in place for them to perform their duties effectively. With proper education and training on how to operate the Mobile iOS© employee/vendor losses would be dramatically reduced with the dual processing capability developed in the Mobile iOS© software can aid in eradicating human errors.

The second reason is employee/vendor theft; theft is a problem that cannot be totally eliminated. Nonetheless, by incorporating the Mobile iOS© theft of inventory can be exposed instantly with the efficient, effective and accurate method of processing inventory via the Mobile iOS© This prompt mode of exposing theft can be used as a means to deter employee/vendor theft.

The third reason is inaccurate inventory counts; Using the Mobile iOS©, inventory is no longer prepared with pencil and paper and memorized in the mind. The Mobile iOS© as our motto states; “The power in your hand” is a smart inventory operating system where the user inputs the data and the dual processing software calibrates and calculates the data and generates a computed ledger of the inventory counts as well the point of sales totals and both are shown on the user's mobile device screen at the push of a button.

The fourth reason is point of sales (POS) inaccuracy; Inventory inaccuracies adversely impact thee\hat{ } bottom line of companies of all industries around the world every day. These inaccuracies can be greatly decreased with the Mobile iOS© dual processing software along with my Virtual Sales Platform (VSP)© which is a software application I invented that integrates with my Mobile iOS©. The Virtual Sales Platform© is an automated sales platform software that processes sales and payments and tracks inventory counts just as the traditional point of sales system. The VSP© system differs from the traditional POS system in that it links directly to the Mobile iOS© database. The VSP© system is designed to help the user obtain accurate inventory counts and the gross sale totals, giving the user the ability to compare, dispute and or eliminate discrepancies that often occur with the traditional point of sale systems. This information users rarely have access to but users are often liable for any shortages that occur. I invented these inventory systems because the inventory process should be made transparent for all entities under-contract and or agreement. Transparency is vital for the success of all entities in an agreement. However, from my experience in the inventory industry, as vendors we are left at the mercy of the companies and or entities we provided service for. As such we are not provided with an adequate way of counting inventory and we are not given the access to specific inventory or sold data from the company and/or the entities point of sales system, which affects our ability to obtain accurate inventory counts and gross sale totals. My Mobile iOS© and VSP© technologies alleviate this dilemma concerning the point of sale for the betterment of all parties involved. Moreover, I invented the iVirtual+System© a cloud database that stores the inventory and sales data of my Mobile iOS© and VSP© system. Integrating these three systems seamlessly in one provides the user(s) with supreme smart technology that manages and store's inventory data.

### SUMMARY OF THE INVENTION

The focal objective of inventing the Mobile iOS© is to help its users save as well as make money by obtaining accurate inventory counts and gross sales totals, advancing the users bottom line while revolutionizing the method of processing inventory by way of the Mobile iOS© proprietary method of accumulating and calculating inventory. Portioning inventory into four distinct counts, the [1 Alpha-count], [2 Anterior-count], [3 Closing-count], and [4 Final-count]. The Alpha-count is the inventory count for each product in the warehouse, stockroom, storeroom, etc., the Anterior-count is the inventory count brought to warehouse floor, store floor, concession stand etc. to be sold, the Closing-count is the count of the leftover inventory that was not sold, the Final-count is the inventory count of the Alpha-count and the. Closing-count computed together for a final inventory count. The Mobile iOS© proprietary software application with its advanced dual processing capability was developed for the sole purpose of computing, managing and maintaining inventory microeconomic and macroeconomic use via a mobile-device and to expedite the method of processing inventory more effectively, efficiently and accurately than ever before. The Mobile iOS© software helps executives, managers, third party vendors and individuals take complete control of their inventory in minutes.

### BRIEF DESCRIPTION OF DRAWINGS

A more complete appreciation of the invention will now be described with reference to the drawings summarized below. The drawings and the associated description(s) thereof are provided to illustrate, the embodiments of the invention of the Mobile iOS©, and not to limit the scope and the breadth of the invention.

FIG. 1 illustrates a simple example of an entity's basic access to the internet (100) through a secured router (200) and Wi-Fi (300) system for a mobile device (400), laptop (500) and computer (600) all located within the company's location, database that stores inventory data on the iVirtual System (700).

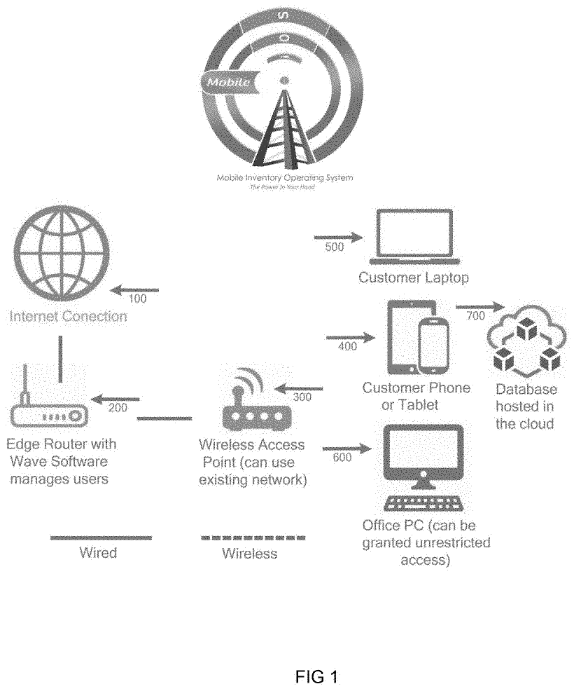

FIG. 2 illustrates the initial menu the user will see once the app is downloaded to their mobile device.

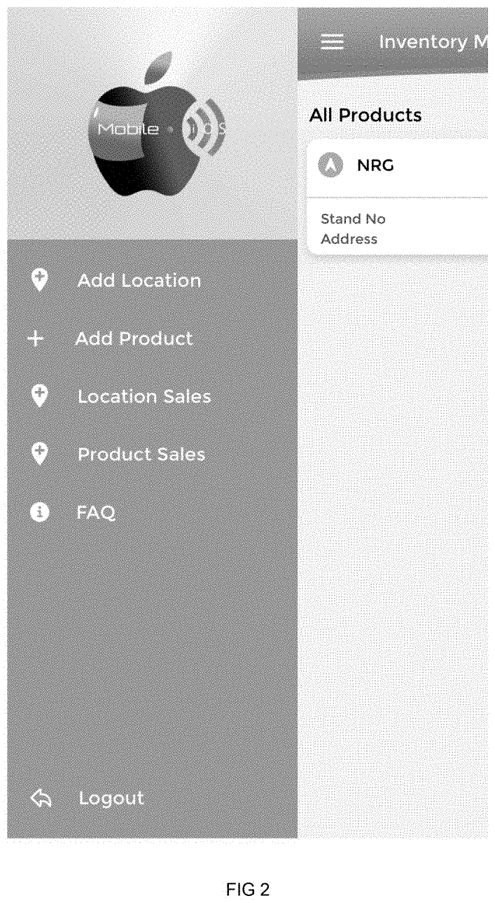

FIG. 3 illustrates the form users will see once they select “Add Location” which will denote the location of the shift, warehouse, kiosk, food truck, etc. “Site” (800), “Locale” (900), “Address” (1000) Once above fields are entered, “Add Location of Product” to save to the Mobile iOS database. (1100)

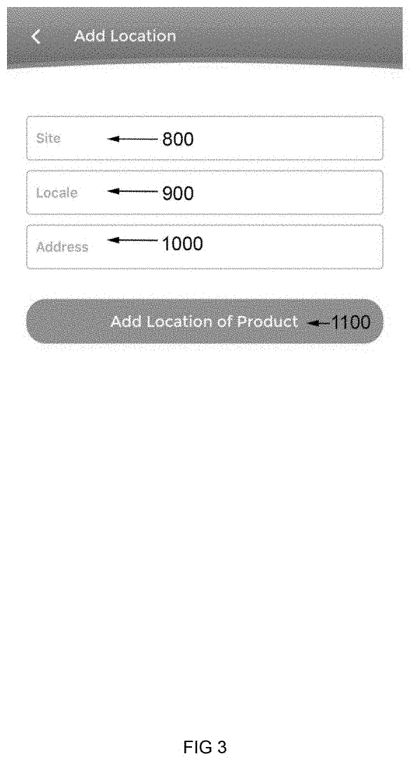

FIG. 4 it lustrates the menu and fields that must be entered to select location (1200), product or item name (1300), the total inventory count of the product (1400), the total amount of the item or product brought to anterior (1500), item or product price (1600), +/−adjustment to Alpha Count (1700), add product to save to the Mobile iOS database. (1800)

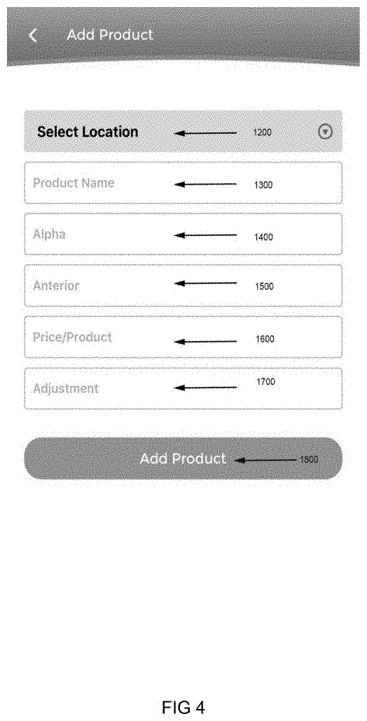

FIG. 5 illustrates the ability to enter end or closing counts (1900), to add a count for damaged items (2000), to update any of the previously entered product fields (2100), and to delete an item or product. (2200)

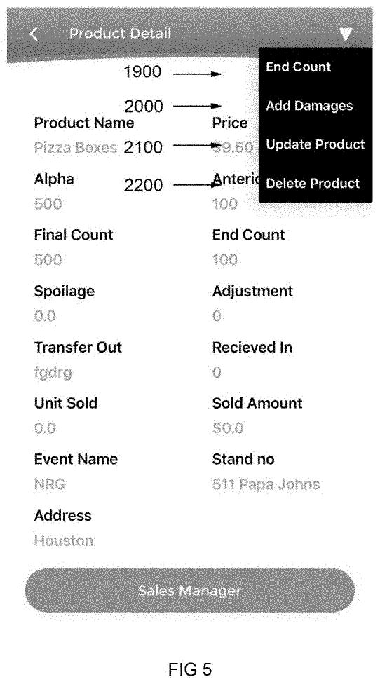

FIG. 6 illustrates the locations entered saved to the Mobile iOS© database system.

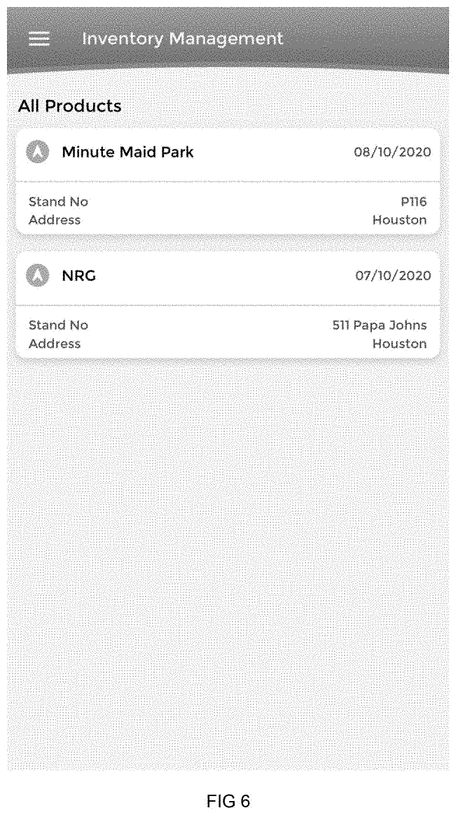

FIG. 7 illustrates the products in list form entered saved into the Mobile iOS© database.

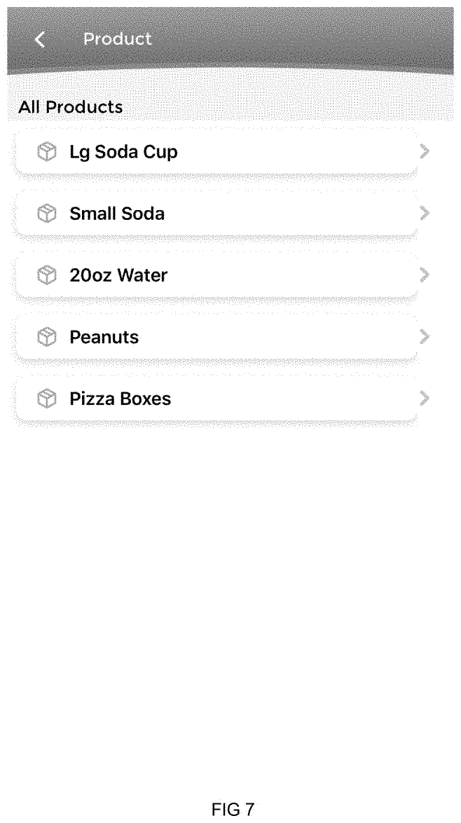

FIG. 8 illustrates how product detail is viewed once entered and selected.

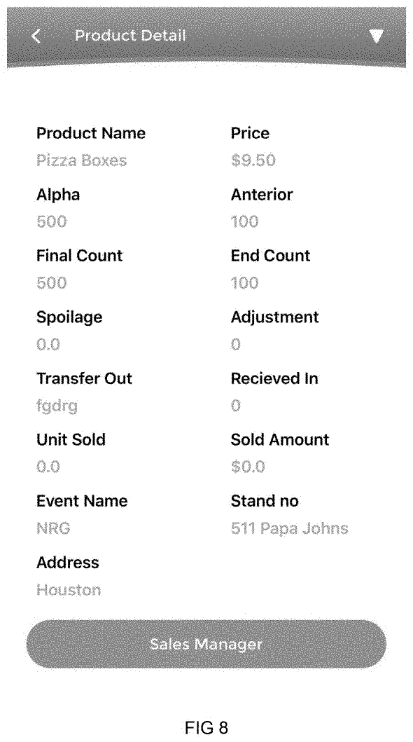

FIG. 9 illustrates the end of day sales view

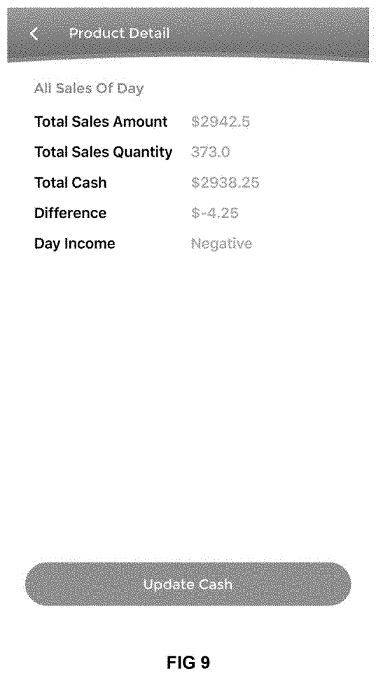

FIG. 10 illustrates the end of day product sales view.

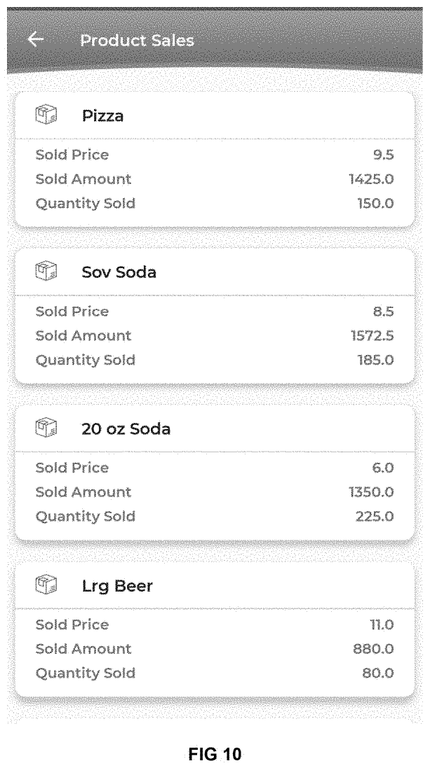

FIG. 11 illustrates the Mobile iOS© ability to scan product by barcode or Q-code to have information auto-populate the form (FIG. 2) such as the product name and the [¹ Alpha-count].

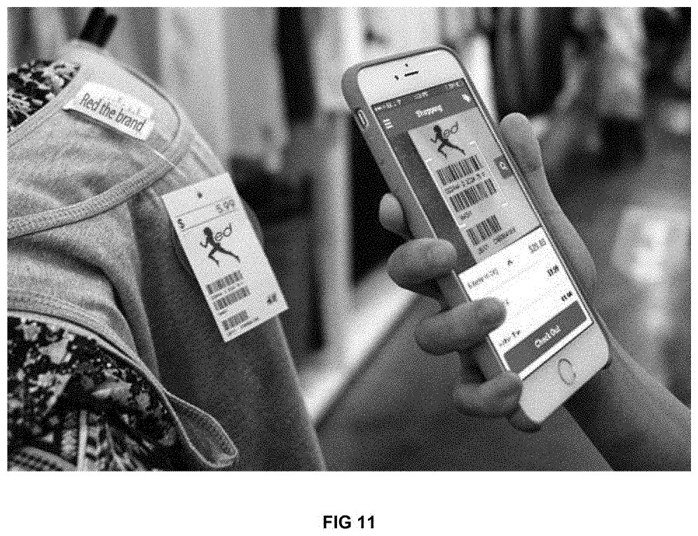

FIG. 12 illustrates the complete NADHTML software solutions systems which include the Mobile iOS©, the VSP© and iVirtual Systems©.

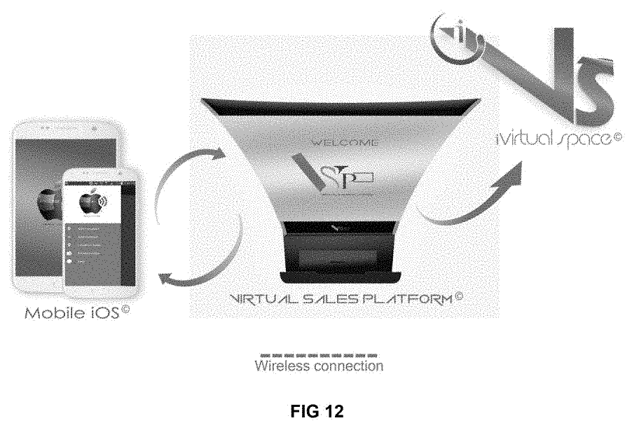

### DETAILED DESCRIPTION OF THE PRESENT INVENTION

The invention of the Mobile iOS© is now described more fully hereinafter with reference to the accompanying drawings, in which preferred embodiments of the invention are shown. Like numbers refer to like elements throughout. This invention may, however, be embodied in many different forms and should not be construed as limited to the embodiments set forth herein; rather, these embodiments are provided so that this disclosure will be thorough and complete, and will fully convey the Scope and Breadth of the invention to those skilled in the art. Aspects of the present invention are directed to assisting those who work directly with inventory and managing sales.

The initial step for the use of the Mobile iOS is downloading the provisioned software application to the user's mobile device(s) smartphone, tablet or laptop etc. When downloaded the user must create an account with a username and password. Users must confirm the account by logging into the email account used to create username and password in order to activate it.

After the account is confirmed the user will be able to log into the Mobile iOS app and choose from two options. Option 1 is the ability to connect to the VSP system and have the inventory populated on their device. Option 2 is for the user to enter the specific products the user needs to track by manually entering the product name, the [1 Alpha-count], and the [2 Anterior-count] then saves that data to the Mobile iOS database.

The data is saved, now the user can either enter another item or preview the items the user has already entered. When all the items are entered the user can click on the preview list to make sure the information entered is correct. When the preview list is pulled up the user can select the item to preview or update the product information.

When the product is tapped, the detail item description screen will pop up and show the user all the information related to that product. On that screen the user has four options, the user can add a new product, delete the current product the user is viewing, or update the product information. Finally, the user can go back to the preview list.

The information is entered, and the user confirms the information is correct the user can close the app until ready to enter the [3 Closing-count].

Once the user is ready to close out for the day or shift the user will log back into the app, pull up the date the user is working on, and click the preview list so the user can enter the [3 Closing-count] for each product.

The preview list is pulled up on the user's mobile device. The user will tap the item the user is entering the [3 Closing-count] for. Then the user will click update. This is where the [3 Closing-count] number will be entered. After the popup screen appears the user will click on the [3 Closing-count] section of the form and enter the amount. Once the amount is entered the user will tap the update product button at the bottom of the form and the program will update the product details page to include the [4 Final-count].

When the [3 Closing-count] and the [4 Final-count] have been entered the total sales for that item will be calculated automatically and can be viewed on the detail description page.

Once the entire product [3 Closing-count] has been entered and the [4 Final-count] and total sales amount has been calculated there will appear a total sales button on the home screen of the software application. The user will click the total sales button and be taken to a page that shows the total sales number for each product and totals the amount to give a total sales amount for the day.

At this point if the user has access to the VSP system they will be able to transfer the sales information directly to the app to see if the sales match with the app as well as to check if there are any discrepancies. If the user does not have the VSP or the user is working as a third-party vendor, the user can manually enter the sales total at the end of the night or shift. With the Mobile iOS dual process capability, the user is able to preview the data to see if there is any shortages in the money count as well as preview the data to see if there are any overages in the money to verify any discrepancies.

What is claimed is:

1. A method, comprising:
a mobile software application accumulating and calculating inventory;
for computing, controlling, monitoring, and managing inventory using a mobile device(s) (e.g., smartphones, tablets, smart watches, etc.);
dual processing capability for computing, managing and maintaining inventory;
portioning inventory into four distinct counts, “Alpha count”, “Anterior count”, “End count”, and the “Final count” it also gives user the “unit's sold” total and a real time sales tracker: and
identifies theft or discrepancies in inventory and cash and will aid in prevention or reduction of such.

2. The method as set forth in claim 1, wherein a mobile software application accumulates and calculates inventory through user input.

3. The method recited in claim 1, wherein mobile software is designed to take user input and compute, control, monitor, and manage inventory data by downloading the Mobile iOS app to their mobile device.

4. The method as set forth in claim 3, wherein user downloads the Mobile iOS app through the app store to be installed on a mobile device of their choice.

5. The method as set forth in claim 1, wherein the software's dual processing is that it computes, manages and maintain the inventory while also processing the inventory cash totals automatically after user imputes the data.

6. The method as set forth in claim 1, wherein the inventory is portioned into four distinct inventory counts, alpha count, anterior count, end count, and final count, which count the units sold totals providing a real time sales tracker.

7. The method as set forth in claim 6, wherein the alpha count is, user counts the inventory in the warehouse, store, kiosk etc. product by product and enters the total count in the software interface as the alpha count.

8. The method as set forth in claim 6, wherein the user will then separate a portion of the inventory from the alpha count and bring it to the front of the store, or out of storage only products and product quantities that are expected to sell for the day and enter this amount, the anterior count into the software UI.

9. The method as set forth in claim 6, wherein through the separation of the anterior from the alpha there is now an end count, which is the remaining inventory left unsold excluding damages or spoiled product.

10. The method as set forth in claim 6, wherein the units sold is determined within the software by subtracting the end count from the anterior count.

11. The method set forth in claim 6, wherein the final count is calculated within the software by subtracting the units sold, any damages/spoiled products from the alpha count.

12. The method set forth in claim 6, wherein the inventory sales tracking after entering the final inventory numbers the invention will calculate the inventory cash total in dollars automatically, where the user can compare the inventory cash calculated, to the cash register cash and credit card received.

13. The method as set forth in claim 1, wherein the software automatically calculates inventory sales in cash allowing the user to see if there is a discrepancy in the cash/credit card totals versus what was calculated by the software.
